(19) United States
(12) Patent Application Publication
(10) Pub. No.: US 2009/0292821 A1
(43) Pub. Date: Nov. 26, 2009

(54) Method and apparatus for performance measurement of different network routes between devices

(76) Inventors: Timothy E. Grib, St. Louis, MO (US); Michael A. Brown, University City, MO (US)

Correspondence Address: LEVEL 3 COMMUNICATIONS, LLC;c/o CPA Global, P.O. Box 52050, Minneapolis, MN, 55402, US

(21) Appl. No.: 09/964,232

(22) Filed: Sep. 26, 2001

(51) Int. Cl. G06F 15/173

(52) U.S. Cl. 709/238

(57) ABSTRACT

Methods and apparatus are disclosed for performance measurement of different network routes between devices. Typically, a network includes multiple paths between a first device and a second device. A first performance test is conducted over a first path between the first and second devices. A second performance test is also conducted over a second path between the first and second devices. These first and the second performance tests are performed simultaneously or within a close time proximity so that comparative data can be derived. These tests may be conducted in response to client requests, which may be scheduled to limit the interference with tests conducted by the same or other client. The types of performance tests performed is extensible, and may include, inter alia, any network, transport layer or other measurements, such as, but not limited to network layer round trip latency, loss, one-way jitter, and hop count.

### FIELD OF THE INVENTION

This invention especially relates to communications and computer systems; and more particularly, the invention relates performance measurement of different network routes between devices.

### BACKGROUND OF THE INVENTION

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology. Increasingly, public and private communications networks are being built and expanded using various packet technologies, such as Internet Protocol (IP).

The Internet has become an important means of communications for businesses and individuals. Many businesses communicate over the Internet to reach other locations and other businesses. In addition to security concerns, the Internet does not provide any guaranteed level of service, which may be especially important to certain businesses. For example, certain important data may need to be communicated in real-time or be transmitted with a guaranteed level of bandwidth. This has lead some businesses to employ dedicated private networks over purchased or leased communications facilities, which can be quite expensive. Additionally, communications service providers have developed their own networks in which they can control the traffic, and provide some guaranteed level of service.

A network device, such as a switch or router, typically receives, processes, and forwards or discards a packet based on one or more criteria, including the type of protocol used by the packet, addresses of the packet (e.g., source, destination, group), and type or quality of service requested. Additionally, one or more security operations are typically performed on each packet.

Routers can be used to forward packets over different communications networks. For example, directly or via an Internet Service Provider, a customer may connect to multiple networks, such as the Internet, communication service provider networks, and private networks. All or select traffic can be directed to be forwarded over identified networks. For example, a business could primarily communicate over a communications service providers guaranteed level of service network, with backup, overflow, or low priority traffic transmitted across the Internet. Technically, such an approach works well. Of course, these communications providers charge for their communications services. The extra cost versus benefit of these services can sometimes be illusive. Needed are methods and systems for quantifying the benefit of using one network over another.

### SUMMARY OF THE INVENTION

Systems and methods are disclosed for performance measurement of different network routes between devices. In one embodiment, a network includes multiple paths between a first device and a second device. A first performance test of a first type is conducted over a first path between the first and second devices. A second performance test of the first type is also conducted over a second path between the first and second devices. These first and the second performance tests are performed simultaneously or within a close time proximity so that comparative data can be derived.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIGS. 1, 2A-B are block diagrams of embodiments for performance measurement of different network routes between devices;

FIG. 3 is a block diagram of processes and data structures used in one embodiment for scheduling performance tests and collecting data;

FIGS. 4A-B are flow diagrams of exemplary processes used in one embodiment for receiving scheduling requests and for scheduling performance tests;

FIGS. 5A-B are flow diagrams of exemplary processes used in one embodiment for receiving scheduling instructions and for conducting performance tests; and

FIGS. 6A-B are flow diagrams of exemplary processes used in one embodiment for receiving and reporting performance test results.

### DETAILED DESCRIPTION

Methods and apparatus are disclosed for performance measurement of different network routes between devices. Embodiments described herein include various elements and limitations, with no one element or limitation contemplated as being a critical element or limitation. Each of the claims individually recite an aspect of the invention in its entirety. Moreover, some embodiments described may include, but are not limited to, inter alia, systems, networks, integrated circuit chips, embedded processors, ASICs, methods, and computer-readable medium containing instructions. The embodiments described hereinafter embody various aspects and configurations within the scope and spirit of the invention, with the figures illustrating exemplary and non-limiting configurations.

As used herein, the term “packet” refers to packets of all types, including, but not limited to, fixed length cells and variable length packets, each of which may or may not be divisible into smaller packets or cells. Moreover, these packets may contain one or more types of information, including, but not limited to, voice, data, video, and audio information. Furthermore, the term “system” is used generically herein to describe any number of components, elements, sub-systems, devices, packet switch elements, packet switches, routers, networks, computer and/or communication devices or mechanisms, or combinations of components thereof. The term “computer” is used generically herein to describe any number of computers, including, but not limited to personal computers, embedded processors and systems, control logic, ASICs, chips, workstations, mainframes, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps and processing of signals and information illustrated in the figures are typically be performed in a different serial or parallel ordering and/or by different components in various embodiments in keeping within the scope and spirit of the invention. Moreover, the terms “network” and “communications mechanism” are used generically herein to describe one or more networks, communications mediums or communications systems, including, but not limited to the Internet, private or public telephone, cellular, wireless, satellite, cable, local area, metropolitan area and/or wide area networks, a cable, electrical connection, bus, etc., and internal communications mechanisms such as message passing, interprocess communications, shared memory, etc. The terms “first,” “second,” etc. are typically used herein to denote different units (e.g., a first element, a second element). The use of these terms herein does not necessarily connote an ordering such as one unit or event occurring or coming before the another, but rather provides a mechanism to distinguish between particular units. Moreover, the phrase “based on x” is used to indicate a minimum set of items x from which something is derived, wherein “x” is extensible and does not necessarily describe a complete list of items on which the operation is based. Additionally, the phrase “coupled to” is used to indicate some level of direct or indirect connection between two elements or devices, with the coupling device or devices modify or not modifying the coupled signal or communicated information.

Methods and apparatus are disclosed for performance measurement of different network routes between devices. Typically, a network includes multiple paths between a first device and a second device. A first performance test of a first type is conducted over a first path between the first and second devices. A second performance test of the first type is also conducted over a second path between the first and second devices. These first and the second performance tests are performed simultaneously or within a close time proximity so that comparative data can be derived. These tests may be conducted in response to client requests, which may be scheduled to limit the interference with tests conducted by the same or other client. The types of performance tests performed is extensible, and may include, inter alia, any network, transport layer or other measurements, such as, but not limited to network layer round trip latency, loss, one-way jitter, and hop count.

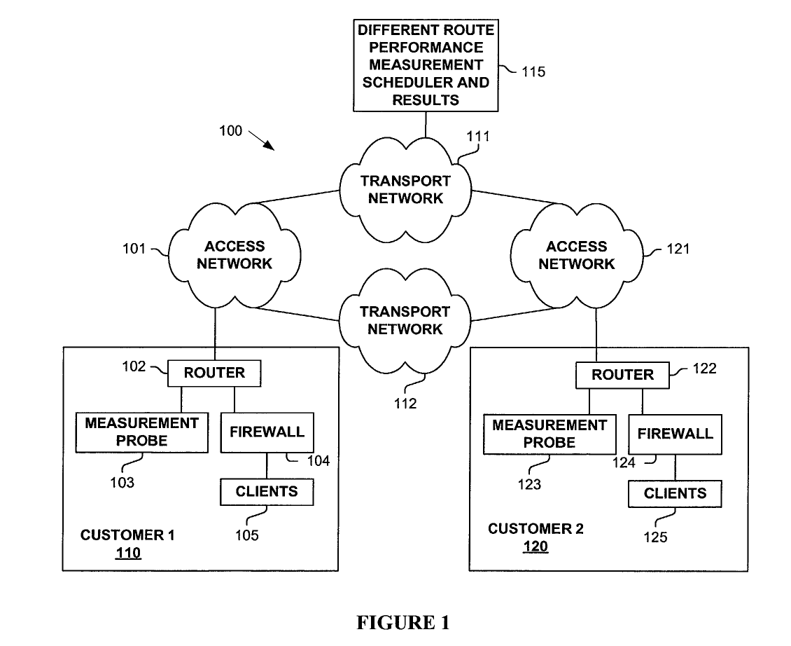

FIG. 1 illustrates one embodiment of a network 100 including devices for scheduling and conducting performance measurement of different network routes between devices. Of course, network 100 as illustrated in FIG. 1 is only one exemplary embodiment of an unlimited number of embodiments within the scope and spirit of the invention. Moreover, the terms “access network” and “transport network” used to only to describe certain portions of a network as illustrated in the figures, wherein the invention is not limited to any specific configuration or network type designation. Rather, the invention is extensible and applicable for conducting performance measurements across any two or more paths through one or more networks.

As shown, network 100 includes two customer locations 110 and 120, which may correspond to a single or multiple customers. Two transport networks 111 and 112 interconnected two access networks 101 and 121, which interconnect customer locations 110 and 120. Customer location 110 includes a router 102, a measurement probe 103 used in conducting the performance tests, a firewall 104, and one or more client devices 105 (e.g., computers, etc.) which may be used to request scheduling of performance tests and for review the results. Customer location 120 includes a router 122, a measurement probe 123 used in conducting the performance tests, a firewall 124, and one or more client devices 125 (e.g., computers, etc.) which may be used to request scheduling of performance tests and for review the results. Network 100 further includes different route performance measurement scheduler and results device 115 which is shown connected to transport network 111 for illustrative purposes, although could be located anywhere within network 100 or another network. In one embodiment, different route performance measurement scheduler and results device 115 receives performance testing requests from clients 105 and 125, forwards testing instructions to measurement probes 103 and 123 which conduct the performance tests, receives results from measurement probes 103 and 123, and provides results to clients 105 and 125. Although performance measurement tests are described herein as conducted between two probes or specialized devices (which provide some logistic and other advantages), the performance tests can be conducted between any two devices (e.g., computers, client devices, routers, communications devices, etc.) having at least two paths interconnection them across any network (e.g., Internet, private network or leased line, service provider network, etc.)

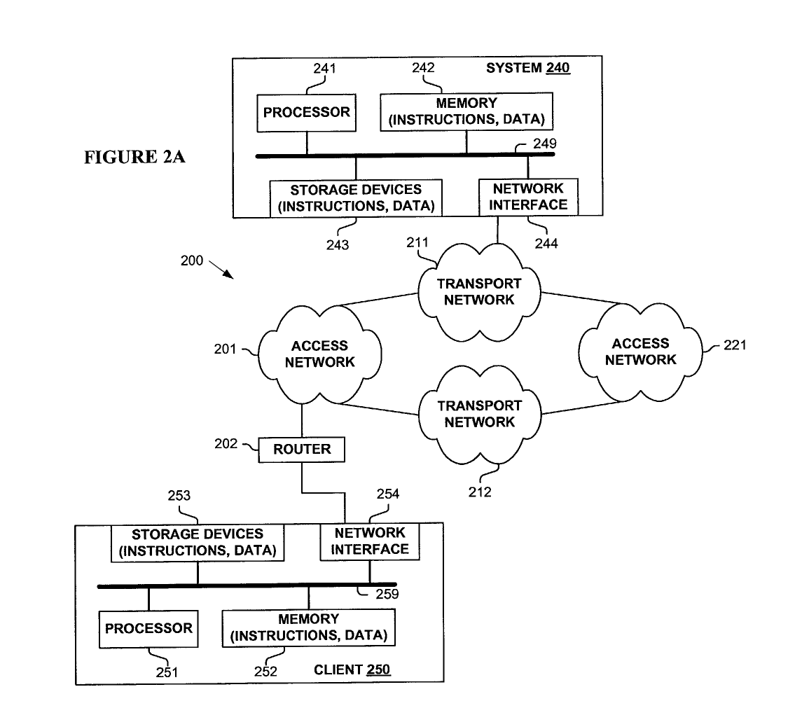

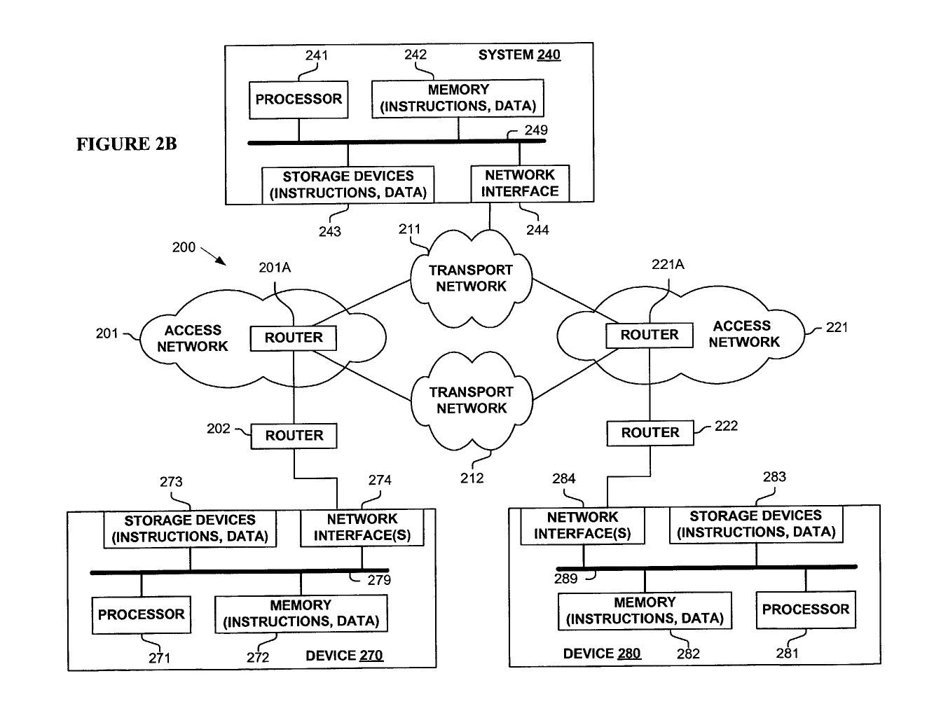

FIGS. 2A and 2B illustrate different views of a network 200 including devices for scheduling and conducting performance measurement of different network routes between devices.

As shown in FIG. 2A, network 200 includes access networks 201 and 221 and transport networks 211 and 212, and a client 250 which schedules performance tests with, and receive results from system 240.

In one embodiment, system 240 includes a processor 241, memory 242, storage devices 243, and network interface 244, which are electrically coupled via one or more communications mechanisms 249 (shown as a bus for illustrative purposes). Various embodiments of system 240 may include more or less elements. The operation of system 240 is typically controlled by processor 241 using memory 242 and storage devices 243 to perform one or more tasks or processes. Memory 242 is one type of computer-readable medium, and typically comprises random access memory (RAM), read only memory (ROM), flash memory, integrated circuits, and/or other memory components. Memory 242 typically stores computer-executable instructions to be executed by processor 241 and/or data which is manipulated by processor 241 for implementing functionality in accordance with the invention. Storage devices 243 are another type of computer-readable medium, and typically comprise solid state storage media, disk drives, diskettes, networked services, tape drives, and other storage devices. Storage devices 243 typically store computer-executable instructions to be executed by processor 241 and/or data which is manipulated by processor 241 for implementing functionality in accordance with the invention.

As used herein and contemplated by the invention, computer-readable medium is not limited to memory and storage devices; rather computer-readable medium is an extensible term including other storage and signaling mechanisms including interfaces and devices such as network interface cards and buffers therein, as well as any communications devices and signals received and transmitted, and other current and evolving technologies that a computerized system can interpret, receive, and/or transmit.

In one embodiment, client 250 includes a processor 251, memory 252, storage devices 253, and network interface 254, which are electrically coupled via one or more communications mechanisms 259 (shown as a bus for illustrative purposes). Various embodiments of system 240 may include more or less elements. The operation of client 250 is typically controlled by processor 251 using memory 252 and storage devices 253 to perform one or more tasks or processes.

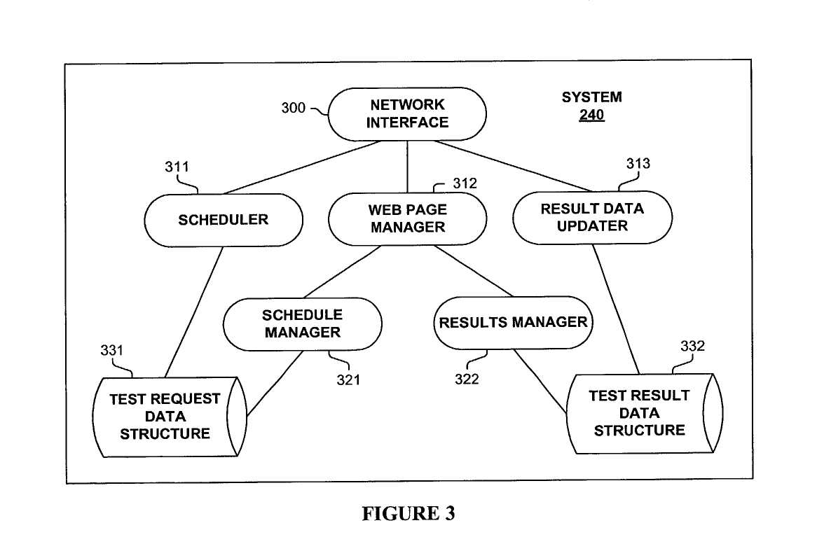

FIG. 3 further illustrates system 240 by showing processes and data structures used in one embodiment for scheduling performance tests and collecting data. One or more network interface processes 300 are used to communicate externally to system 240. A web page manager 312 provides a user interface to client 250 (FIG. 2A) and transmits received scheduling requests to schedule manager 321 which consults with and updates test request data structure 331 in scheduling tests. Scheduler 311, in response to scheduled performance tests maintained in test request data structure 331, sends testing instructions to measurement probes and other devices. Result data updater 313 receives the results of such tests via network interface 300 and populates a test result data structure 332. A results manager 322 manipulates and provides results to web page manager 312 for presentation to client 250. These results may presented or downloaded in any desired form or format, such as, but not limited to tabular, graphical, and raw data.

FIG. 2B illustrates another view of network 200 which includes devices 270 and 280 for performing the actual performance tests. In one embodiment, device 270 includes a processor 271, memory 272, storage devices 273, and network interface 274, which are electrically coupled via one or more communications mechanisms 279 (shown as a bus for illustrative purposes). Various embodiments of device 270 may include more or less elements. The operation of device 270 is typically controlled by processor 271 using memory 272 and storage devices 273 to perform one or more tasks or processes.

In one embodiment, device 280 includes a processor 281, memory 282, storage devices 283, and network interface 284, which are electrically coupled via one or more communications mechanisms 289 (shown as a bus for illustrative purposes). Various embodiments of device 280 may include more or less elements. The operation of device 280 is typically controlled by processor 281 using memory 282 and storage devices 283 to perform one or more tasks or processes.

As further shown in FIG. 2B, device 270 is connected to access network 201 through router 202, and device 280 is connected to access network 221 through router 222. Furthermore, access networks 201 and 221 are shown to include routers 201A and 221A, respectively, for routing traffic among two paths between devices 270 and 280.

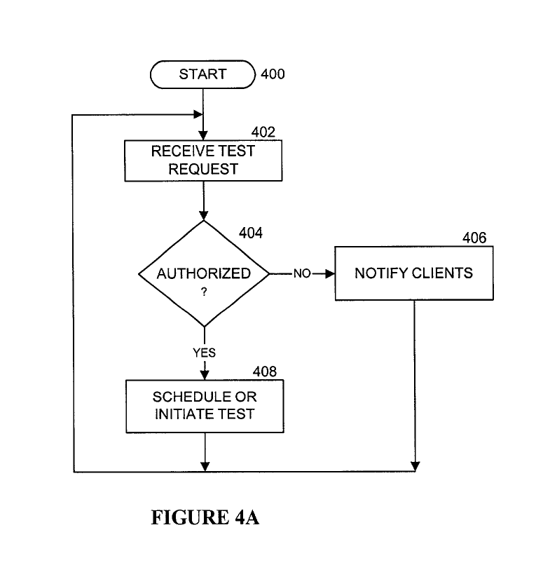

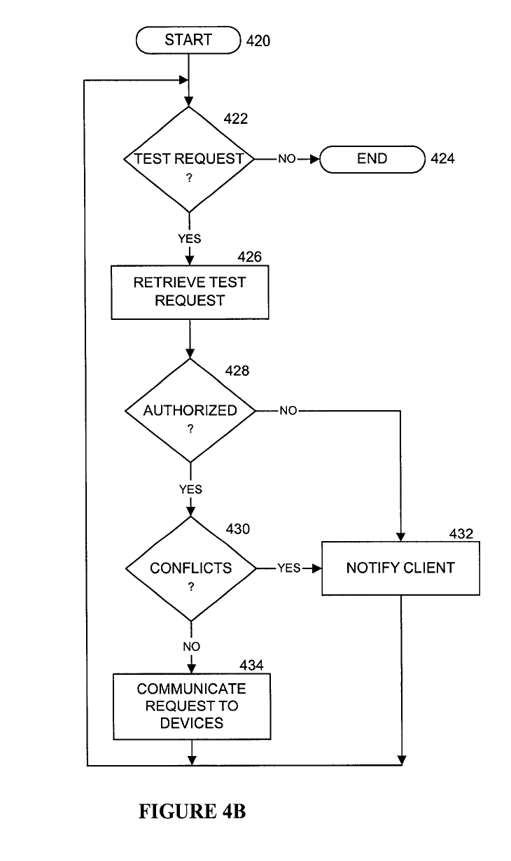

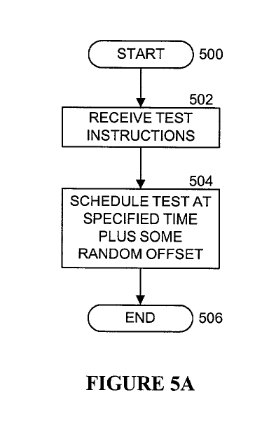

The operation of various scheduling devices, testing probes and devices, and client devices and computers are further described in relation to the flow diagrams of FIGS. 4A-B, 5A-B, and 6A-B.

FIG. 4A illustrates a process used in one embodiment for scheduling tests requests received from a client device or other mechanism. Processing begins with process block 400, and proceeds to process block 402, wherein a test request is received. Next, as determined in process block 404, if the test request is not authorized (e.g., from a client that does not have the appropriate security or other rights), then typically one or more clients or operators are notified in process block 406, such as via email or other status message communications techniques. Otherwise, in process block 408, the test request is placed in a test request data structure or the test is actually initiated. Processing returns to process block 402 to receive and process more request.

FIG. 4B illustrates a process used in one embodiment for retrieving from a data structure and processing scheduling requests (or directly receiving them). In one embodiment, this process is initiated at a specific time (e.g., midnight), in response to receiving a test scheduling request, or in reaction to any other event or notification. Processing begins with process block 420, and proceeds to process block 422. While there remains test requests to process, processing continues to process block 426 to retrieve a next test request from a data structure. Next, as determined in process block 428, if the test is authorized, then a check is determined in process block 430 to determine whether the requested performance test conflicts with other tests or other traffic within the network. For example, in one embodiment, only a predetermined number of performance tests are allowed to include a specific device or network path. If the test was not authorized or a terminal conflict detected, then in process block 432 the requesting client and/or operators are notified of the failed test request. Otherwise, in process block 434, instructions to conduct the performance test are communicated to the testing device or devices. In one embodiment, when a test is performed between an originating testing device and a terminating testing device, test instructions are communicated to the originating testing device, and a notification is communicated to the terminating testing device which, if required, in response initiates a testing process in preparation of receiving test packets (e.g., an echo process for measuring roundtrip delay). Processing then returns to process block 422. When there are now more test requests, processing is completed as indicated by process block 424.

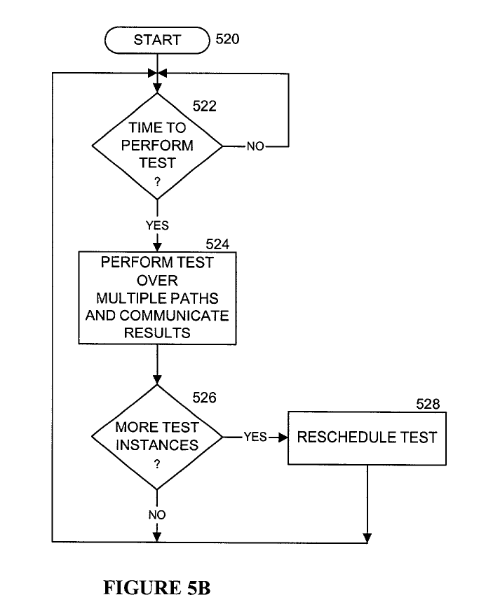

FIG. 5A illustrates an exemplary process used in one embodiment of a testing device to receive testing instructions and to schedule a test. Processing begins with process block 500, and proceeds to process block 502 to receive the test instructions. Next, in process block 504, the specific performance test is scheduled at the specified time, plus some random offset time. A random offset time component is used in one embodiment to randomly vary the actual time of a performance test to help avoid tests from other devices from being performed at the exact same instant. For example, if a performance test is to be conducted regularly over an extend time duration (e.g., every n seconds for several minutes, hours or days), a random time value ranging from zero to one-half the period between tests is used. Of course, another time staggering methodology is used in one embodiment. Processing is complete as indicated by process block 506.

FIG. 5B illustrates an exemplary process used a testing device in one embodiment to schedule and conduct the actual performance test. Processing begins at process block 520. Processing loops at process block 522 until it is time to conduct a test. Then, in process block 524, a performance test is simultaneously or within a close time proximity performed over the two or more paths between the devices, and the results recorded or reported to another process or device. The types of performance tests performed is extensible, and may include, inter alia, any network, transport layer or other measurements, such as, but not limited to network layer round trip latency, loss, one-way jitter, and hop count. Next, as determined in process block 526, if there are more instances of the test to be performed (e.g., it is to be conducted periodically over an extended time duration), then the next instance of the test is scheduled in process block 528. Processing returns to process block 522 to perform more scheduled tests.

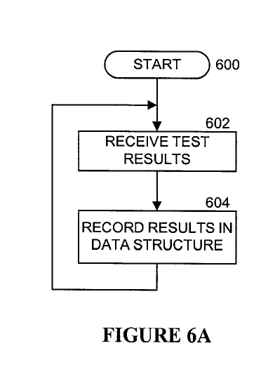

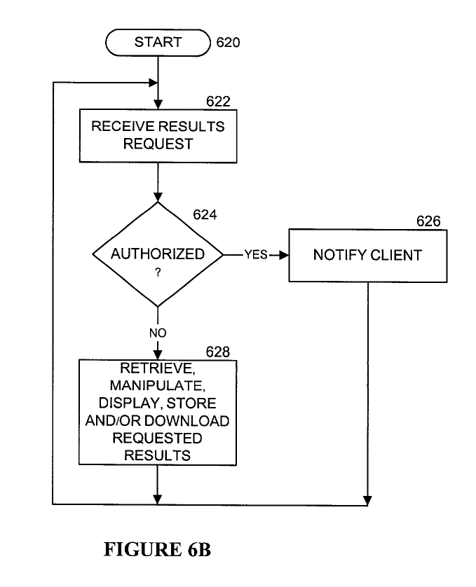

FIG. 6A illustrates an exemplary process used in a data collection device used in one embodiment. Processing begins with process block 600, and proceeds to process block 602, wherein testing results are received. Next, in process block 604, these testing results are recorded in a data structure, and processing returns to process block 602.

FIG. 6B illustrates an exemplary process used in one embodiment to provide test results to a client or other requesting device or process. Processing begins with process block 620, and proceeds to process block 622, wherein a request for the results of one or more performance tests are received. Next, as determined in process block 624, if the request is not authorized, then in process block 626, the requesting client and/or operator or some process, etc. is notified of the unauthorized request. Otherwise, in process block 628, the test results data is retrieved from a data structure, and manipulated, displayed, stored, downloaded or provided in any other way or format as requested. Processing returns to process block 622.

In view of the many possible embodiments to which the principles of our invention may be applied, it will be appreciated that the embodiments and aspects thereof described herein with respect to the drawings/figures are only illustrative and should not be taken as limiting the scope of the invention. For example and as would be apparent to one skilled in the art, many of the process block operations can be re-ordered to be performed before, after, or substantially concurrent with other operations. Also, many different forms of data structures could be used in various embodiments. The invention as described herein contemplates all such embodiments as may come within the scope of the following claims and equivalents thereof.

1. A method performed by one or more components in a network comprising a plurality of paths between a first device and a second device, the method comprising:
conducting a first performance test of a first type over a first path of the plurality of paths between the first and second devices;
conducting a second performance test of the first type over a second path of the plurality of paths between the first and second devices; and
wherein a processor initiates the simultaneous execution of the first and the second non-sequential performance tests.

2. The method of claim 1, wherein the first performance test produces a first set of results;
wherein the second performance test produces a second set of results; and
further comprising presenting a service level performance comparison based on the first and second sets of results.

3. The method of claim 2, wherein the first performance test includes a plurality of first individual performance tests performed over an extended time duration; and
the second performance test includes a plurality of second individual performance tests performed over the extended time duration.

4. The method of claim 3, wherein each of the pluralities of first and second individual performance tests are performed at roughly periodic intervals over the extended time duration.

5. The method of claim 1, wherein the first path transverses a first access network, a first transport network, and a second access network; and the second path transverses the first access network, a second transport network, and the second access network.

6. The method of claim 1, further comprising receiving a scheduling request representing the first and second performance tests.

7. The method of claim 6, wherein the scheduling request is received by a scheduling system; and the scheduling system communicates a first indication of the request to the first device.

8. The method of claim 7, wherein the scheduling system further communicated a second indication of the request to the second device.

9. The method of claim 6, further comprising scheduling the first and second performance tests based on the scheduling request and a random time component.

10. The method of claim 6, further comprising determining whether the scheduling request is authorized.

11. The method of claim 10, further comprising indicating that the scheduling request is not authorized.

12. The method of claim 6, further comprising determining whether the scheduling request conflicts with a second scheduling request.

13. The method of claim 6, further comprising determining whether a number of scheduled tests exceeds a first threshold number for the first device or exceeds a second threshold number for the second device.

14. The method of claim 13, further comprising indicating a failed scheduling request.

15. A computer-readable medium containing computer-executable instructions for performing a method by steps comprising:
conducting a first performance test of a first type over a first path of a plurality of paths between a first and second devices;
conducting a second performance test of the first type over a second path of the plurality of paths between the first and second devices; and
wherein a processor initiates the simultaneous execution of the first and the second non-sequential performance tests.

16. A network comprising:
a plurality of paths between a first device and a second device;
means for conducting a first performance test of a first type over a first path of the plurality of paths between the first and second devices;
means for conducting a second performance test of the first type over a second path of the plurality of paths between the first and second devices; and
wherein a processor initiates the simultaneous execution of the first and the second non-sequential performance tests.

17. The network of claim 16, wherein said means for conducting the first performance test includes means for generating a first set of results;
wherein said means for conducting the second performance test includes means for generating a second set of results; and
further comprising means for presenting a service level performance comparison based on the first and second sets of results.

18. The network of claim 16, wherein the first path transverses a first access network, a first transport network, and a second access network; and the second path transverses the first access network, a second transport network, and the second access network.

19. The network of claim 16, further comprising means for receiving a scheduling request representing the first and second performance tests.

20. The network of claim 19, further comprising means for scheduling the first and second performance tests based on the scheduling request and a random time component.

21. A network comprising:
a first device coupled to a first access network;
the first access network coupled to a first and a second transport networks;
a second access network coupled to the first and the second transport networks;
a second device coupled to the second access network; and
wherein a processor initiates the simultaneous execution of a performance test between the first device and the second device over each of the first and second transport networks simultaneously.

22. The network of claim 21, wherein the first device is coupled to a first router, wherein the first router selectively routes performance testing packets received from the first device over a first path to the first transport network and a second path to the second transport network.

23. The network of claim 21, further comprising a performance test scheduler.

24. The network of claim 23, further comprising a client device, wherein the client device transmits one or more scheduling requests for the performance test.

25. The network of claim 24, further comprising a results collector for receiving a set of results associated with the performance test.

26. The network of claim 25, wherein the results collector transmits at least a subset of the set of results to the client device.

27. The network of claim 23, wherein the performance test scheduler communicates a scheduling instruction associated with the performance test to the first device.

28. The network of claim 27, wherein the performance test scheduler communicates a second scheduling instruction associated with the performance test to the second device.

29. The network of claim 28, wherein the second device includes a test mode; and wherein the second device enters the test mode in response to receiving the second scheduling instruction.
